(19) United States
(12) Patent Application Publication
(10) Pub. No.: US 2019/0116791 A1
(43) Pub. Date: Apr. 25, 2019

(54) USE OF SAFENERS WITH PPO INHIBITOR HERBICIDES

(71) Applicant: FMC CORPORATION, PHILADELPHIA, PA (US)

(72) Inventors: Sandra L. Shinn, Columbus, NJ (US); Gurinderbir S. Chahal, PLymouth, MN (US); Frank J. D'Amico, JR., Robbinsville, NJ (US)

(21) Appl. No.: 16/085,573

(22) PCT Filed: Mar. 6, 2017
(86) PCT No.: PCT/US17/20942

§ 371 Date: Sep. 15, 2018

Related U.S. Application Data
(60) Provisional application No. 62/308,256, filed on Mar. 15, 2016.

(51) Int. Cl. A01N 43/42; A01N 43/56; A01N 43/653; A01N 43/82; A01N 43/16

(52) U.S. Cl. CPC A01N 43/42; A01N 43/56; A01N 43/16; A01N 43/82; A01N 43/653

(57) ABSTRACT

Methods, compositions, and methods for making compositions for reducing crop injury by applying to crops a composition containing one or more safeners and an herbicide composition containing a protoporphyrinogen oxidase (PPO) inhibitor are disclosed. In particular aspects, the safener composition contains cloquintocet-mexyl and/or mefenpyr-diethyl.

### FIELD OF THE INVENTION

The presently disclosed subject matter relates to the field of agricultural compositions and formulations, specifically to compositions and formulations of safeners for use with herbicides.

### BACKGROUND OF THE INVENTION

One of the more preferred methods of controlling weeds in crops involves the post-emergent control of weeds wherein herbicide(s) are applied after the crop in question has emerged from the soil. Post-emergent control is desirable as it requires the application of herbicide only where an infestation of weeds is present. In contrast, pre-emergent control requires the application of herbicide early in the growing season before most weeds have germinated, with the result that such chemicals must be employed throughout a field even if they would ultimately not be needed.

Protoporphyrinogen oxidase (PPO) is an enzyme found in both plants and animals, which is responsible for the seventh step in the biosynthesis of protoporphyrin IX. This porphyrin is the biosynthetic precursor of hemoglobin in animals and chlorophyll in plants. The enzyme catalyzes the dehydrogenation of protoporphyrinogen IX to form protoporphyrin IX.

Quick acting herbicides such as PPO herbicides are not safe on many crops when applied postemergence. Protoporphyrinogen oxidase inhibitors (PPO) are herbicides that act by blocking the production of chlorophyll and heme in a plant, causing an accumulation of protoporphyrinogen IX that is ultimately toxic to the plant.

For example, herbicides such as carfentrazone-ethyl and fluthiacet-methyl may cause injury to cereal crops.

Safeners are compounds used in combination with herbicides to make the herbicide “safer” for use on crops. This may include reducing the effect of the herbicide on crop plants, and/or improving selectivity between crop plants and the weed species targeted by the herbicide.

### SUMMARY OF THE INVENTION

One aspect of the invention is directed to a method of selectively controlling weeds in a crop, comprising applying to the crop weeds a herbicidally effective amount of a herbicidal composition comprising a quick acting herbicide and an effective amount of a safener composition.

In certain aspects, the safener composition comprising one or more safeners selected from the group consisting of cloquintocet-mexyl, mefenpyr-diethyl, benoxacor, dichlormid, isoxadifen-ethyl, cyprosulfamide, fenclorim, fenchlorazole-ethyl, fluxofenim, naphthalic anhydride, cyometrinil, oxabetrinil, flurazole, furilazole, daimuron, cumyluron, dimepiperate, and dietholate.

In certain aspects, the quick acting herbicide comprises herbicides of protoporphyrinogen oxidase (PPO) inhibitor classes, diquat, paraquat, glufosinate-ammonium, and bialaphos.

Another aspect of the invention is directed to a method of selectively controlling weeds in a crop, comprising applying to the crop weeds a herbicidally effective amount of a herbicidal composition comprising a protoporphyrinogen oxidase (PPO) inhibitor and an effective amount of a safener composition. In certain aspects, the safener comprises cloquintocet-mexyl, mefenpyr-diethyl, or a mixture thereof.

In certain aspects, a formulation is disclosed comprising a protoporphyrinogen oxidase (PPO) inhibitor herbicide and a safener composition. In aspects, the safener comprises cloquintocet-mexyl, mefenpyr-diethyl, or a mixture thereof.

In aspects, a method is disclosed for making a formulation for selectively controlling weeds in a crop, comprising combining an herbicidal composition comprising a protoporphyrinogen oxidase (PPO) inhibitor and a composition comprising a safener. In certain aspects, the safener composition comprises cloquintocet-mexyl, mefenpyr-diethyl, or a mixture thereof.

### DETAILED DESCRIPTION

As used in this application and unless otherwise indicated the term “herbicide” refers to a compositional mixture that is produced, sold, or used in a field in order to kill or otherwise inhibit unwanted plants such as, but not limited to, deleterious or annoying weeds, broadleaf plants, grasses, and sedges; and can be used for crop protection, edifice protection or turf protection. The term “herbicide” includes the end-use herbicidal product. This composition can be a pure compound, a solution of chemical compounds, a mixture of chemical compounds, an emulsion, a suspension, a solid-liquid mixture, or a liquid-liquid mixture. The term “herbicide” also refers to the product that passes through the commercial channels from the manufacturer to the ultimate end user who can either apply the herbicide to the affected field as sold, or mix it with other excipients.

The term “weed” means and includes any plant which grows where it is not wanted, including volunteer crop plants or insecticide resistant plants.

The term “effective”, when used with respect to an herbicide, or “herbicidally effective amount” means an amount necessary to produce an observable herbicidal effect on unwanted plant growth, including one or more of the effects of necrosis, death, growth inhibition, reproduction inhibition, inhibition of proliferation, and removal, destruction, or otherwise diminishing the occurrence and activity of unwanted plants.

The term “herbicidally active ingredient” means the active ingredient in the herbicide that causes the herbicide to prevent, destroy, repel or mitigate any weed. Other ingredients of the herbicide that are not herbicidally active ingredients are excipients that aid in forming, storing, or delivering herbicidally active ingredient to the target.

The definition of the term “herbicidal composition” refers to a herbicide, and in addition, to any composition that comprises a herbicidally active ingredient. This composition can be a solution or a mixture. Further, the definition of the term “herbicidal composition” also refers to a product intended for use in manufacturing, or any product intended for formulation or repackaging into other agricultural products.

As used herein, the terms “labeled use rate” or “registered use rate” or “labeled application rate” or “registered application rate” as applied to herbicidal compositions refer to the rate of application to a field containing crops and/or weeds, which rate has been established by the agrochemical industry, as reflected in Environmental Protection Agency (EPA) regulations, to be appropriate for control of the indicated weed species. The registered use rate is reflected on the commercial formulation packaging in an appropriate label.

Quick acting herbicides such as PPO herbicides are not safe on many crops when applied postemergence. For example, carfentrazone-ethyl is known to cause injury to cereals. The herbicide fluthiacet-methyl is not labeled on cereals because it is not safe on cereals. In this document, the present inventors have demonstrated that co-application of safener/safener mixtures provides safety to cereals from these herbicides. Additionally, it is believed that the use of safener composition with these herbicides may expand their usefulness on cereal crops.

In certain embodiments, herbicide and safener may be applied separately. In other embodiments, a mixture comprising herbicide and safener may be applied.

One aspect of the invention is directed to a method of selectively controlling weeds in a crop, comprising applying to the crop weeds a herbicidally effective amount of a herbicidal composition comprising a quick acting herbicide and an effective amount of a safener composition.

In embodiments, the safener composition comprising one or more safeners selected from the group consisting of cloquintocet-mexyl, mefenpyr-diethyl, benoxacor, dichlormid, isoxadifen-ethyl, cyprosulfamide, fenclorim, fenchlorazole-ethyl, fluxofenim, naphthalic anhydride, cyometrinil, oxabetrinil, flurazole, furilazole, daimuron, cumyluron, dimepiperate, and dietholate.

In embodiments, the quick acting herbicide comprises protoporphyrinogen oxidase (PPO) inhibitor, diquat, paraquat, glufosinate-ammonium, and bialaphos.

Examples of these PPO inhibitors include, without limitation, acifluorfen, acifluorfen-sodium, azafenidin, bifenox, butafenacil, chlomethoxyfen, chlornitrofen, ethoxyfen-ethyl, fluorodifen, fluoroglycofen-ethyl, fluoronitrofen, fomesafen, furyloxyfen, halosafen, lactofen, nitrofen, nitrofluorfen, oxyfluorfen, flumiclorac-pentyl, flumioxazine, profluazol, pyrazogyl, oxadiargyl, oxadiazon, pentoxazone, fluazolate, pyraflufen-ethyl, benzfendizone, butafenacil, cinidon-ethyl, flumipropyn, flupropacil, fluthiacet-methyl, thidiazimin, azafenidin, carfentrazone, carfentrazone-ethyl, sulfentrazone, saflufenacil, flufenpyr-ethyl, ET-751, JV 485, nipyraclofen, or mixtures of two or more thereof.

Another aspect of the invention is directed to a method of selectively controlling weeds in a crop, comprising applying to the crop weeds a herbicidally effective amount of a herbicidal composition comprising a protoporphyrinogen oxidase (PPO) inhibitor and applying an effective amount of a composition comprising a safener composition.

Another aspect of the invention is directed to a method of selectively controlling weeds in a crop, comprising applying to the crop weeds a formulation comprising a protoporphyrinogen oxidase (PPO) inhibitor and a safener composition.

In embodiments, the safener may be selected from the group consisting of cloquintocet-mexyl, mefenpyr-diethyl, daimuron, cumylron, dimepiperate, fenclorim, fenchlorazole-ethyl, isoxadifen-ethyl, cyprosulfamide, benoxacor, dichlormid, furilazole, flurazole, oxabetrinil, cyometrinil, naphthalic anhydride, dietholate, fluxofenim, and mixtures thereof. In embodiments, the safener is preferably cloquintocet-mexyl, mefenpyr-diethyl, or a mixture thereof.

In embodiments, the PPO inhibitor may be selected from the group consisting of carfentrazone, carfentrazone-ethyl, sulfentrazone, fluthiacet-methyl, saflufenacil, and mixtures of two or more thereof. In embodiments, the PPO inhibitor is preferably carfentrazone-ethyl or fluthiacet-methyl.

In another embodiment, the protoporphyrinogen oxidase (PPO) inhibitor is selected from diphenyl ethers, oxadiazoles, cyclic imides or pyrazoles. Examples of these PPO classes include, without limitation, acifluorfen, acifluorfen-sodium, azafenidin, bifenox, butafenacil, chlomethoxyfen, chlornitrofen, ethoxyfen-ethyl, fluorodifen, fluoroglycofen-ethyl, fluoronitrofen, fomesafen, furyloxyfen, halosafen, lactofen, nitrofen, nitrofluorfen, oxyfluorfen, flumiclorac-pentyl, flumioxazine, profluazol, pyrazogyl, oxadiargyl, oxadiazon, pentoxazone, fluazolate, pyraflufen-ethyl, benzfendizone, butafenacil, cinidon-ethyl, flumipropyn, flupropacil, fluthiacet-methyl, thidiazimin, azafenidin, carfentrazone, carfentrazone-ethyl, sulfentrazone, saflufenacil, flufenpyr-ethyl, ET-751, JV 485, nipyraclofen, or mixtures of two or more thereof.

The herbicidal compositions of the present disclosure can be in any conventional agriculturally useful form, for example, in the form of a twin pack, or in a ready-to-use formulation, or in the form of a tank mix. Additionally, the active compounds can be supplied (either separately or pre-mixed) in any appropriate formulation type, for example an emulsion concentrate (EC), a suspension concentrate (SC), a suspo-emulsion (SE), a capsule suspension (CS), a water dispersible granule (WG), an emulsifiable granule (EG), a water in oil emulsion (EO), an oil in water emulsion (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a dispersible concentrate (DC), a wettable powder (WP), a mixed heterogeneous formulation of CS and EW (ZW), or any other technically feasible formulation in combination with agriculturally acceptable adjuvants. For tank mixing, commercial formulations of PPO inhibitor and safener are combined in a tank prior to application, in the appropriate ratio to provide the targeted weight ratio of the active ingredients. In certain embodiments, the herbicidal compositions of the present disclosure are tank mixes. In other embodiments, the herbicidal compositions of the present disclosure are supplied as premix emulsifiable concentrates (ECs).

Rates of application of the compositions, or tank-mixed separately formulated active ingredients, will vary according to prevailing conditions such as targeted weeds, degree of infestation, weather conditions, soil conditions, crop species, mode of application, and application time. Compositions comprising PPO inhibitor and/or safener can be applied as sprays, such as water-dispersible concentrates, wettable powders, or water-dispersible granules.

In embodiments, the application rate of each active ingredient (“ai”), such as an herbicide or safener, may be varied from crop to crop. In embodiments, different ranges of application rates may be used for different PPO inhibitor herbicides. In embodiments, the rate of application for herbicide is from about 5 g active ingredient/hectare (g ai/ha) to about 420 g ai/ha. In embodiments, the rate of application for safener is from about 5 g ai/ha to about 350 g ai/ha, or about 10 to about 300 g ai/ha. In embodiments, the ratio between safener and herbicide is about 10:1 (safener/herbicide) to about 1:30 (safener/herbicide) by weight.

In one embodiment, the present disclosure describes an agricultural formulation or tank mix comprising a quick acting herbicide and a safener compositon. The quick acting herbicide may include PPOs. In embodiments, the PPO inhibitor is selected from carfentrazone, carfentrazone-ethyl, sulfentrazone, fluthiacet-methyl, saflufenacil, or mixtures of two or more thereof. In embodiments, the PPO inhibitor is preferably carfentrazone-ethyl or fluthiacet-methyl. In embodiments, the safener comprises cloquintocet-mexyl, mefenpyr-diethyl, or a mixture thereof. In embodiments, the safener composition and the quick acting herbicide are present in a ratio between about 10:1 (safener/herbicide) to about 1:30 (safener/herbicide) by weight. In embodiments, these can be commercial formulations that are tank mixed at the time of application, or in the form of a suitable premix formulation. Suitable premix formulations include, without limitation, suspension concentrate (SC) and emulsifiable concentrate (EC).

In embodiments, the crop may be selected from the group consisting of genetically modified and non-modified turf, wheat, barley, corn, rice, sorghum, oats, and triticale.

In embodiments, susceptible weed species may include, without limitation, redroot pigweed, Palmer amaranth, common waterhemp, velvetleaf, morningglory species, nightshade species, common lambsquarters, wild mustard, red stem filaree, field pennycress, common mellow, smooth pigweed, prostrate pigweed, spiny amaranth, spurde annoda, catchweed bedstraw, cocklebur, carpet weed, eclipta, jimsonweed, kochia, groundcherry, prickly lettuce, London rocket, shepherd's-purse, Russian thistle, yellow nutsedge, purple nutsedge, common ragweed, horseweed, giant ragweed, common chickweed, mouseear chickweed, hairy galinsoga, American daisy, smartweeds, chamomile mayweed, wild pointsettia, common purslane, prickly sida, large crabgrass, smooth crabgrass, goosegrass, orchardgrass, fall panicum, witchgrass, stinkgrass, hairy beggarticks, field bindweed, wild buckwheat, dandelion, knotweed prostrate, mustard species, Canada thistle, sow thistle, annual thistle, and spiny thistle.

The compositions and tank mixes of the present disclosure can additionally comprise further crop protection agents, including, but not limited to, fungicides, insecticides, nematicides, plant growth regulators, herbicides other than PPO herbicides, fertilizers, and mixtures thereof.

In embodiments, the control of the weed is effective through at least about 14 days post treatment, preferably at least about 60 days post treatment.

The compositions of the present disclosure can also include a preservative. Suitable preservatives include, but are not limited to, C₁₂ to C₁₅ alkyl benzoates, alkyl p-hydroxybenzoates, aloe vera extract, ascorbic acid, benzalkonium chloride, benzoic acid, benzoic acid esters of C₉ to C₁₅ alcohols, butylated hydroxytoluene, butylated hydroxyanisole, tert-butylhydroquinone, castor oil, cetyl alcohols, chlorocresol, citric acid, cocoa butter, coconut oil, diazolidinyl urea, diisopropyl adipate, dimethyl polysiloxane, DMDM hydantoin, ethanol, ethylenediaminetetraacetic acid, fatty acids, fatty alcohols, hexadecyl alcohol, hydroxybenzoate esters, iodopropynyl butylcarbamate, isononyl iso-nonanoate, jojoba oil, lanolin oil, mineral oil, oleic acid, olive oil, parabens, polyethers, polyoxypropylene butyl ether, polyoxypropylene cetyl ether, potassium sorbate, propyl gallate, silicone oils, sodium propionate, sodium benzoate, sodium bisulfite, sorbic acid, stearic fatty acid, sulfur dioxide, vitamin E, vitamin E acetate and derivatives, esters, salts and mixtures thereof. Preferred preservatives include sodium o-phenylphenate, 5-chloro-2-methyl-4-isothiazolin-3-one, 2-methyl-4-isothiazolin-3-one, and 1,2-benisothiazolin-3-one.

The present document discloses compositions and methods that provide efficacy for controlling crop weeds in crops. It has now been demonstrated that the addition of safeners such as cloquintocet-mexyl or mefenpyr-diethyl or safener mixture such as cloquintocet-mexyl plus mefenpyr-diethyl can reduce the crop injury from herbicides such as carfentrazone-ethyl and fluthiacet-methyl without influencing the efficacy of these herbicides. It is believed that co-application of safener/safener mixtures with PPO herbicides will allow higher application rates of herbicides on registered crops and expand their use on crops for which they are not registered.

The following examples serve only to illustrate the invention and should not be interpreted as limiting the scope of the invention in any way, since further modifications encompassed by the disclosed invention will be apparent to those skilled in the art. All such modifications are deemed to be within the scope of the invention as disclosed in the present specification and claims.

### EXAMPLES

### Example 1

### Materials and Methods

To study the safening effect of one or two safeners on crops, carfentrazone-ethyl at 25 or 50 g ai/ha or fluthiacet-methyl at 5.6 or 11.2 g ai/ha* were applied in combination with cloquintocet-mexyl plus mefenpyr-diethyl, cloquintocet-mexyl plus naphthalic anhydride, mefenpyr-diethyl plus naphthalic anhydride, cloquintocet-mexyl, mefenpyr-diethyl, or naphthalic anhydride. Safeners cloquintocet-mexyl, mefenpyr-diethyl, and naphthalic anhydride were applied at 6.6, 27.2, and 74.1 g ai/ha, respectively. Other treatments included the application of carfentrazone-ethyl or fluthiacet-methyl alone. Nonionic surfactant at 0.25% (v/v) was added in all carfentrazone-ethyl and fluthiacet-methyl treatments. Carfentrazone-ethyl and fluthiacet-methyl treatments were applied to crops 10 days after planting. Wheat and weeds were planted in 3″ plastic pots using metro-mix. Treatments were applied using compressed air track spray chamber at 30 GPA using a TeeJet 8001E nozzle at 40 PSI. Data were analyzed using Minitab statistical software at 95% confidence interval. Means of each rating interval of percent wheat injury sharing the same letter are not significantly different at a 95% confidence interval. *Naphthalic anhydride was not included in fluthiacet-methyl studies.

Crop injury was assessed by using a visual rating method. This method is based on a scale of 0-100%, where 0% means no injury and 100% means complete death of the plant. Table 1 shows a linear rating scale that can be used to assess weed control or crop damage. (Modified from Frans, et al., 1986). Crop injury that is less than or equal to 10% is considered commercially acceptable. A rating of injury less or equal to 20% indicates that the crops are not significantly adversely affected and rapidly and completely recover. The level of commercially acceptable crop injury varies from crop to crop. Any injury level greater than 20% is generally not commercially acceptable.

In the present studies, reduction in crop injury from commercially unacceptable to commercially acceptable levels with safener/herbicide treatments was observed.

TABLE 1

| | | Precision |
|---|---|---|
| Rating Weed Control | Percent (%) Crop Damage | (%) |
| 0 No weed control | No crop reduction or injury | 2 |
| 10 Very poor weed control | Slight crop discoloration or | 5 |
| | stunting | |
| 20 Poor weed control | Some crop discoloration, stunting, | 5 |
| | or stunt loss | |
| 30 Poor to deficient weed control | Crop injury more pronounced, but | 10 |
| | not lasting | |
| 40 Deficient weed control | Moderate injury, crop usually | 10 |
| | recovers | |
| 50 Deficient to moderate weed | Crop injury more lasting, recovery | 10 |
| control | doubtful | |
| 60 Moderate weed control | Lasting crop injury, no recovery | 10 |
| 70 Weed control somewhat less than | Heavy crop injury and stand loss | 10 |
| satisfactory | | |
| 80 Satisfactory to good weed control | Crop nearly destroyed - A few | 5 |
| | surviving plants | |
| 90 Very good to excellent weed | Only occasional live crop plants | 5 |
| control | left | |
| 100 Complete weed destruction | Complete crop destruction | 2 |

### Example 2

In greenhouse studies, the safening effect of safeners, cloquintocet-mexyl or mefenpyr-diethyl and safener mixtures, cloquintocet-mexyl plus mefenpyr-diethyl, was investigated on wheat. The efficacy of PPO inhibitor herbicides in the presence of safener or safener mixtures was also studied. To study the safening effect of safeners or safener mixtures, cloquintocet-mexyl at 7.5% w/w and mefenpyr-diethyl at 3.39% w/w were applied with herbicide. Carfentrazone-ethyl was applied at 25 or 50 g ai/ha; fluthiacet-methyl was applied at 5.6 or 11.2 g ai/ha. Safeners were applied at the following rates: cloquintocet-mexyl at 6.61 g ai/ha and mefenpyr-diethyl at 27 g ai/ha. All treatments (solo, tank-mix, premix) were applied at the seedling stage of the crop (10 days after planting). Carfentrazone-ethyl or fluthiacet-methyl was applied alone or in combination with safener or safener mixture.

TABLE 2
Percent wheat injury when carfentrazone-ethyl was applied with different
combinations of safeners, wheat specie “Yellowstone” used

| | | 3 | 7 | 14 |
|---|---|---|---|---|
| Treatments | g ai/ha | DAT | DAT | DAT |
| Cloquintocet-mexyl + Mefenpyr-diethyl + | 6.6 + 27.2 + 25 | 9 (B) | 9 (B) | 6 (B) |
| carfentrazone-ethyl | | | | |
| Cloquintocet-mexyl + Naphthalic anhydride + | 6.6 + 74.1 + 25 | 9 (B) | 8 (B) | 5 (B) |
| carfentrazone-ethyl | | | | |
| Mefenpyr-diethyl + Naphthalic anhydride + | 27.2 + 74.1 + 25 | 11 (B) | 9 (B) | 6 (B) |
| carfentrazone-ethyl | | | | |
| Cloquintocet-mexyl + carfentrazone-ethyl | 6.6 + 25 | 10 (B) | 10 (B) | 6 (B) |
| Mefenpyr-diethyl + carfentrazone-ethyl | 27.2 + 25 | 10 (B) | 9 (B) | 5 (B) |
| Naphthalic anhydride + carfentrazone-ethyl | 74.1 + 25 | 28 (A) | 25 (A) | 15 (A) |
| Carfentrazone-ethyl | 25 | 34 (A) | 28 (A) | 15 (A) |
| Non-treated check | — | 0 (C) | 0 (C) | 0 (C) |

Means of each rating interval of percent wheat injury sharing the same letter are not significantly different at 95% confidence interval.

Wheat injury was assessed by using the visual rating method described above. Percent wheat injury was rated based on the bronzing, chlorosis, and necrosis on wheat foliage by PPO inhibitors. These are typical symptoms (bronzing, chlorosis, and necrosis) of PPO inhibitors on sensitive plants.

In all of the studies, treatments were compared to carfentrazone-ethyl solo treatment. The data in this and other tables indicates that the level of injury to wheat was reduced with the addition of safener or safeners. For instance, at 3 DAT (days after treatment), injury to wheat with carfentrazone-ethyl at 25 g ai/ha was 34% compared to less than or equal to 10% with carfentrazone-ethyl applied with safener (s), for example, cloquinotcet-mexyl+mefenpyr-diethyl.

Regardless of the carfentrazone-ethyl rate, wheat injury in the presence of safener(s) was lower or equivalent to 12% except with naphthalic anhydride alone, where injury was greater than 25% at 3 DAT. Carfentrazone-ethyl alone caused 34% and 43% injury at 25 and 50 g, respectively (Tables 2 and 3).

TABLE 3
Percent wheat injury when carfentrazone-ethyl was applied with different
combinations of safeners, wheat specie “Yellowstone” used

| Treatments | g ai/ha | 3 DAT | 7 DAT | 14 DAT |
|---|---|---|---|---|
| Cloquintocet-mexyl + Mefenpyr- | 6.6 + 27.2 + 50 | 11 (C) | 9 (B) | 6 (C) |
| diethyl + carfentrazone-ethyl | | | | |
| Cloquintocet-mexyl + Naphthalic | 6.6 + 74.1 + 50 | 13 (C) | 9 (B) | 6 (C) |
| anhydride + carfentrazone-ethyl | | | | |
| Mefenpyr-diethyl + Naphthalic | 27.2 + 74.1 + 50 | 13 (C) | 12 (B) | 9 (B) |
| anhydride + carfentrazone-ethyl | | | | |
| Cloquintocet-mexyl + carfentrazone- | 6.6 + 50 | 11 (C) | 11 (B) | 6 (C) |
| ethyl | | | | |
| Mefenpyr-diethyl + carfentrazone- | 27.2 + 50 | 14 (C) | 12 (B) | 9 (B) |
| ethyl | | | | |
| Naphthalic anhydride + | 74.1 + 50 | 36 (B) | 34 (A) | 20 (A) |
| carfentrazone-ethyl | | | | |
| Carfentrazone-ethyl | 50 | 43 (A) | 36 (A) | 20 (A) |
| Non-treated check | — | 0 (D) | 0 (C) | 0 (D) |

Means of each rating interval of percent wheat injury sharing the same letter are not significantly different at 95% confidence interval.

### Example 3

TABLE 4
Percent injury on wheat varieties “Jagger” and “Yellowstone” when
carfentrazone-ethyl was applied with single safener or two safeners 10 days after emergence

| | | Jagger | | | | | | Yellowstone | | | | | |
|---|---|---|---|---|---|---|---|---|---|---|---|---|---|
| Treatments | g ai/ha | 3 DAT | | 7 DAT | | 14 DAT | | 3 DAT | | 7 DAT | | 14 DAT | |
| Cloquintocet-mexyl + | 6.61 + 27 + 25 | 7 | (E) | 5 | (FG) | 2 | (E) | 9 | (EF) | 5 | (G) | 3 | (D) |
| mefenpyr-diethyl + | | | | | | | | | | | | | |
| carfentrazone-ethyl | | | | | | | | | | | | | |
| Cloquintocet-mexyl + | 6.61 + 27 + 50 | 7 | (E) | 3 | (G) | 3 | (DE) | 7 | (F) | 5 | (G) | 4 | (D) |
| mefenpyr-diethyl + | | | | | | | | | | | | | |
| carfentrazone-ethyl | | | | | | | | | | | | | |
| Cloquintocet-mexyl + | 6.61 + 25 | 12 | (DE) | 9 | (DE) | 7 | (D) | 16 | (D) | 10 | (EF) | 10 | (BC) |
| carfentrazone-ethyl | | | | | | | | | | | | | |
| Cloquintocet-mexyl + | 6.61 + 50 | 11 | (DE) | 8 | (DEF) | 6 | (DE) | 13 | (DE) | 9 | (F) | 9 | (BC) |
| carfentrazone-ethyl | | | | | | | | | | | | | |
| Mefenpyr-diethyl + | 27 + 25 | 12 | (DE) | 7 | (D-G) | 5 | (DE) | 13 | (DE) | 9 | (F) | 8 | (CD) |
| carfentrazone-ethyl | | | | | | | | | | | | | |
| Mefenpyr-diethyl + | 27 + 50 | 36 | (B) | 31 | (B) | 26 | (AB) | 36 | (B) | 30 | (C) | 24 | (A) |
| carfentrazone-ethyl | | | | | | | | | | | | | |
| Mefenpyr-diethyl + | 25 | 14 | (D) | 11 | (D) | 7 | (D) | 15 | (D) | 14 | (E) | 10 | (BC) |
| carfentrazone-ethyl | | | | | | | | | | | | | |
| (premix) | | | | | | | | | | | | | |
| Mefenpyr-diethyl + | 50 | 21 | (C) | 18 | (C) | 15 | (C) | 21 | (C) | 18 | (D) | 14 | (B) |
| carfentrazone-ethyl | | | | | | | | | | | | | |
| (premix) | | | | | | | | | | | | | |
| Cloquintocet-mexyl + | 25 | 9 | (DE) | 6 | (EFG) | 4 | (DE) | 9 | (EF) | 5 | (G) | 5 | (CD) |
| carfentrazone-ethyl | | | | | | | | | | | | | |
| (premix) | | | | | | | | | | | | | |
| Cloquintocet-mexyl + | 50 | 11 | (DE) | 9 | (DE) | 5 | (DE) | 13 | (DE) | 10 | (F) | 8 | (BCD) |
| carfentrazone-ethyl | | | | | | | | | | | | | |
| (premix) | | | | | | | | | | | | | |
| Carfentrazone-ethyl | 25 | 36 | (B) | 34 | (AB) | 25 | (B) | 38 | (B) | 34 | (B) | 24 | (A) |
| Carfentrazone-ethyl | 50 | 43 | (A) | 38 | (A) | 30 | (A) | 44 | (A) | 39 | (A) | 28 | (A) |

Means of each rating interval of percent wheat injury sharing the same letter are not significantly different at 95% confidence interval.

The results shown demonstrate that, regardless of carfentrazone-ethyl rate and rating intervals (3 and 7 DAT), wheat injury to both varieties (Jagger & Yellowstone) in the presence of cloquintocet-mexyl plus mefenpyr-diethyl or cloquintocet-mexyl alone was 13% or lower (Table 4).

Similar results were seen with premix of carfentrazone-ethyl+cloquintocet-mexyl. Application of mefenpyr-diethyl with carfentrazone-ethyl at 50 g as tank-mix or premix caused greater than 20% injury to both varieties (Table 4). Injury to both varieties with carfentrazone-ethyl without safener at 25 or 50 g was >35% or >40%, respectively (Table 4).

Percent weed control was determined by a method similar to the 0 to 100% rating system as described above and reproduced below for easy reference. The same weed control rating system also can be found such as in “Research Methods in Weed Science,” 2nd ed., B. Truelove, Ed.; Southern Weed Science Society; Auburn University, Auburn, Ala., 1977.

TABLE 5
Weed Control Rating System

| | Description | |
|---|---|---|
| Rating Percent | of Main | |
| Control | Categories | Weed Description |
| 0 | No Effect | No weed control |
| 10 | | Very poor weed control |
| 20 | Slight Effect | Poor weed control |
| 30 | | Poor to deficient weed control |
| 40 | | Deficient weed control |
| 50 | Moderate Effect | Deficient to moderate weed control |
| 60 | | Moderate weed control |
| 70 | | Control somewhat less than |
| | | satisfactory |
| 80 | Severe | Satisfactory to good weed control |
| 90 | | Very good to excellent weed control |
| 100 | Complete Effect | Complete weed destruction |

Control of velvetleaf and morningglory with all treatments was 100% at 7 DAT (Table 6)

TABLE 6
Percent weed control when carfentrazone-ethyl was applied with single safener or
two safeners 10 days after emergence

| | | Velvetleaf | | Morningglory | |
|---|---|---|---|---|---|
| Treatments | g ai/ha | 3 DAT | 7 DAT | 3 DAT | 7 DAT |
| Cloquintocet-mexyl + | 6.61 + 27 + 25 | 90 (A) | 100 | 90 (A) | 100 (A) |
| mefenpyr-diethyl + | | | (A) | | |
| carfentrazone-ethyl | | | | | |
| Cloquintocet-mexyl + | 6.61 + 27 + 50 | 90 (A) | 100 | 90 (A) | 100 (A) |
| mefenpyr-diethyl + | | | (A) | | |
| carfentrazone-ethyl | | | | | |
| Cloquintocet-mexyl + | 6.61 + 25 | 90 (A) | 100 | 90 (A) | 100 (A) |
| carfentrazone-ethyl | | | (A) | | |
| Cloquintocet-mexyl + | 6.61 + 50 | 90 (A) | 100 | 90 (A) | 100 (A) |
| carfentrazone-ethyl | | | (A) | | |
| Mefenpyr-diethyl + | 27 + 25 | 90 (A) | 100 | 90 (A) | 100 (A) |
| carfentrazone-ethyl | | | (A) | | |
| Mefenpyr-diethyl + | 27 + 50 | 90 (A) | 100 | 90 (A) | 100 (A) |
| carfentrazone-ethyl | | | (A) | | |
| Mefenpyr-diethyl + | 25 | 90 (A) | 100 | 90 (A) | 100 (A) |
| carfentrazone (premix) | | | (A) | | |
| Mefenpyr-diethyl + | 50 | 90 (A) | 100 | 90 (A) | 100 (A) |
| carfentrazone-ethyl | | | (A) | | |
| (premix) | | | | | |
| Cloquintocet-mexyl + | 25 | 90 (A) | 100 | 90 (A) | 100 (A) |
| carfentrazone-ethyl | | | (A) | | |
| (premix) | | | | | |
| Cloquintocet-mexyl + | 50 | 90 (A) | 100 | 90 (A) | 100 (A) |
| carfentrazone-ethyl | | | (A) | | |
| (premix) | | | | | |
| Carfentrazone-ethyl | 25 | 90 (A) | 100 | 90 (A) | 100 (A) |
| | | | (A) | | |
| Carfentrazone-ethyl | 50 | 90 (A) | 100 | 90 (A) | 100 (A) |
| | | | (A) | | |

Means of each rating interval of percent weed control sharing the same letter are not significantly different at 95% confidence interval.

### Example 4

TABLE 7
Percent wheat injury when fluthiacet-methyl (F-M) was applied as tank-mix with the
safeners cloquintocet-mexyl (C-M) or mefenpyr-diethyl (M-D) combined or alone

| | | Test 1 | | | | | | | | | | | | Test 2 | | | | | |
|---|---|---|---|---|---|---|---|---|---|---|---|---|---|---|---|---|---|---|---|
| | | YELLOWSTONE (1) | | | | | | JAGGER | | | | | | YELLOWSTONE (2) | | | | | |
| Treatment | Rate | 3 DAT | | 7 DAT | | 14 DAT | | 3 DAT | | 7 DAT | | 14 DAT | | 3 DAT | | 7 DAT | | 14 DAT | |
| C-M + M-D + | 6.6 + 27.2 + | 0 | (D) | 1 | (C) | 4 | (CD) | 0 | (B) | 1 | (D) | 2 | (CD) | 8 | (CD) | 6 | (CD) | 5 | (EF) |
| F-M | 5.6 | | | | | | | | | | | | | | | | | | |
| C-M + M-D + | 6.6 + 27.2 + | 2 | (CD) | 3 | (C) | 4 | (CD) | 2 | (B) | 2 | (D) | 4 | (BCD) | 14 | (BC) | 12 | (BC) | 8 | (CDE) |
| F-M | 11.2 | | | | | | | | | | | | | | | | | | |
| C-M + F-M | 6.6 + 5.6 | 3 | (CD) | 2 | (C) | 4 | (CD) | 2 | (B) | 2 | (D) | 6 | (BC) | 15 | (BC) | 10 | (BC) | 8 | (CDE) |
| C-M + F-M | 6.6 + 11.2 | 5 | (BCD) | 4 | (C) | 9 | (BC) | 1 | (B) | 4 | (CD) | 7 | (BC) | 21 | (B) | 14 | (BC) | 14 | (BC) |
| M-D + F-M | 27.2 + 5.6 | 4 | (CD) | 4 | (C) | 5 | (CD) | 1 | (B) | 4 | (CD) | 5 | (BCD) | 6 | (CD) | 7 | (CD) | 6 | (DEF) |
| M-D + F-M | 27.2 + 11.2 | 8 | (BC) | 12 | (B) | 10 | (BC) | 4 | (B) | 10 | (B) | 8 | (BC) | 23 | (B) | 18 | (B) | 21 | (AB) |
| F-M | 5.6 | 12 | (B) | 12 | (B) | 12 | (B) | 6 | (B) | 8 | (BC) | 10 | (B) | 16 | (BC) | 11 | (BC) | 12 | (CD) |
| F-M | 11.2 | 36 | (A) | 34 | (A) | 34 | (A) | 35 | (A) | 35 | (A) | 19 | (A) | 40 | (A) | 36 | (A) | 25 | (A) |

In both tests (1 & 2) shown in Table 7, fluthiacet-methyl applied alone injured (≥10%) Yellowstone variety of wheat at both rates, Jagger wheat was safe (≥10% injury) when fluthiacet-methyl was applied alone at 5.6 g ai/ha. In Test 1, Yellowstone (1) and Jagger were safe when fluthiacet-methyl was applied with either safener alone or in combination at 14 DAT. In test 1, velvetleaf and morningglory were controlled in all cases (data not shown). In Test 2, Yellowstone (2) was safe 14 DAT when fluthiacet-methyl was applied at 5.6 or 11.2 g with cloquintocet-mexyl plus mefenpyr-diethyl applied as tank-mix. Fluthiacet-methyl at 5.6 g with either safener was safe on Yellowstone at 14 DAT.

Where features or aspects of the invention are described in terms of a Markush group or other grouping of alternatives, those skilled in the art will recognized that the invention is also thereby described in terms of any individual member or subgroup of members of the Markush group or other group.

Unless indicated to the contrary, all numerical ranges described herein include all combinations and subcombinations of ranges and specific integers encompassed therein. Such ranges are also within the scope of the described invention.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1. A method of selectively controlling weeds in a crop, comprising applying to the crop weeds a herbicidally effective amount of a herbicidal composition comprising a quick acting herbicide and an effective amount of a safener composition.

2. A method of claim 1, wherein the safener composition comprising one or more safeners selected from the group consisting of cloquintocet-mexyl, mefenpyr-diethyl, benoxacor, dichlormid, isoxadifen-ethyl, cyprosulfamide, fenclorim, fenchlorazole-ethyl, fluxofenim, naphthalic anhydride, cyometrinil, oxabetrinil, flurazole, furilazole, daimuron, cumyluron, dimepiperate, and dietholate.

3. A method of claim 1, wherein the quick acting herbicide is selected from the group consisting of protoporphyrinogen oxidase (PPO) inhibitor, diquat, paraquat, glufosinate-ammonium, bialaphos, or mixtures thereof.

4. A method of claim 1, comprising applying to the crop weeds a herbicidally effective amount of a herbicidal composition comprising a protoporphyrinogen oxidase (PPO) inhibitor and an effective amount of a safener composition.

5. The method of claim 4, wherein the safener composition comprises cloquintocet-mexyl, mefenpyr-diethyl, or a mixture thereof.

6. The method of claim 4, wherein the protoporphyrinogen oxidase inhibitor is selected from the group consisting of carfentrazone, carfentrazone-ethyl, sulfentrazone, fluthiacet-methyl, saflufenacil, and mixtures of two or more thereof.

7. The method of claim 4, wherein the weeds are selected from the group consisting of redroot pigweed, Palmer amaranth, common waterhemp, velvetleaf, morningglory species, nightshade species, common lambsquarters, wild mustard, red stem filaree, field pennycress, common mellow, smooth pigweed, prostrate pigweed, spiny amaranth, spurde annoda, catchweed bedstraw, cocklebur, carpet weed, eclipta, jimsonweed, kochia, groundcherry, prickly lettuce, London rocket, shepherd's-purse, Russian thistle, yellow nutsedge, purple nutsedge, common ragweed, horseweed, giant ragweed, common chickweed, mouseear chickweed, hairy galinsoga, American daisy, smartweeds, chamomile mayweed, wild pointsettia, common purslane, prickly sida, large crabgrass, smooth crabgrass, goosegrass, orchardgrass, fall panicum, witchgrass, stinkgrass, hairy beggarticks, field bindweed, wild buckwheat, dandelion, knotweed prostrate, mustard species, Canada thistle, sow thistle, annual thistle, and spiny thistle.

8. The method of claim 4, wherein the crop is selected from the group consisting of genetically modified and non-modified turf, wheat, barley, corn, rice, sorghum, oats, and triticale.

9. The method of claim 4, wherein control of the weed is effective through at least 14 days post treatment.

10. The method of claim 4, wherein the protoporphyrinogen oxidase (PPO) inhibitor and safener are applied simultaneously, separately or sequentially.

11. The method of claim 4, wherein the safener and protoporphyrinogen oxidase (PPO) inhibitor are applied in a ratio of from about 10:1 (safener/herbicide) to about 1:30 (safener/herbicide) by weight.

12. The method of claim 4, wherein the the protoporphyrinogen oxidase (PPO) inhibitor is applied in a rate of from about 5 g ai/ha to about 420 g ai/ha.

13. The method of claim 4, wherein the safener is applied in a rate of from about 5 g ai/ha to about 350 g ai/ha.

14. A formulation comprising a protoporphyrinogen oxidase (PPO) inhibitor herbicide and a safener composition, wherein the saferner composition comprises cloquintocet-mexyl, mefenpyr-diethyl, or a mixture thereof.

15. The formulation of claim 14, wherein the protoporphyrinogen oxidase (PPO) inhibitor is selected from the group consisting of carfentrazone, carfentrazone-ethyl, sulfentrazone, fluthiacet-methyl, saflufenacil, and mixtures of two or more thereof.

16. A method of making a formulation for selectively controlling weeds in a crop, comprising combining a herbicidal composition comprising a protoporphyrinogen oxidase (PPO) inhibitor and a composition comprising a safener, wherein the safener composition comprises cloquintocet-mexyl, mefenpyr-diethyl, or a mixture thereof.
